(19) United States
(12) Patent Application Publication
(10) Pub. No.: US 2026/0118876 A1
(43) Pub. Date: Apr. 30, 2026

(54) INDOOR MAP CONSTRUCTION METHOD, ROBOT AND COMPUTER-READABLE STORAGE MEDIUM

(71) Applicant: UBTECH ROBOTICS CORP LTD, Shenzhen (CN)

(72) Inventors: SIMIN ZHANG, Shenzhen (CN); Dongxu Peng, Shenzhen (CN); Jiahao Ji, Shenzhen (CN); Yongsheng Zhao, Shenzhen (CN); Jichao Jiao, Shenzhen (CN)

(21) Appl. No.: 19/432,252

(22) Filed: Dec. 24, 2025

Related U.S. Application Data
(63) Continuation of application No. PCT/CN2024/142936, filed on Dec. 26, 2024.

(30) Foreign Application Priority Data
Aug. 22, 2024 (CN) 202411162370.5

(51) Int. Cl. G05D 1/246; G01S 17/89; G05D 105/80; G05D 109/10; G05D 111/10; G06V 10/24; G06V 10/75; G06V 10/762; G06V 20/56

(52) U.S. Cl. CPC G05D 1/246; G01S 17/89; G06V 10/242; G06V 10/751; G06V 10/762; G06V 20/56; G05D 2105/87; G05D 2109/10; G05D 2111/17

(57) ABSTRACT

An indoor map construction method includes: after a robot enters a mapping mode, acquiring initial point cloud data at a starting position; extracting, from the initial point cloud data, a first principal direction; after rotating the initial point cloud data according to the first principal direction, controlling the robot to travel a preset distance so as to acquire updated point cloud data; extracting a second principal direction from the updated point cloud data; when the first principal direction is different from the second principal direction, rotating the acquired point cloud data according to the second principal direction and controlling the robot to continue traveling, until indoor global point cloud data are obtained; extracting a third principal direction from the global point cloud data; and when the second principal direction is different from the third principal direction, rotating the global point cloud data according to the third principal direction.

### CROSS REFERENCE TO RELATED APPLICATIONS

The present application is a continuation-application of International Application PCT/CN2024/142936, with an international filing date of Dec. 26, 2024, which claims foreign priority to Chinese Patent Application No. 202411162370.5, filed on Aug. 22, 2024, in the China National Intellectual Property Administration, the contents of all of which are hereby incorporated by reference in its entirety.

### TECHNICAL FIELD

The present disclosure generally relates to the data processing, and in particular, relates to an indoor map construction method, a robot and a computer-readable storage medium.

### BACKGROUND

When a cleaning robot moves indoors to perform mapping, the robot typically establishes a map of a surrounding environment in real time based on environmental information detected by a LiDAR sensor, thereby facilitating map-based cleaning path planning and related operations. The initial orientation of the cleaning robot at the start of mapping is usually uncertain. For example, a user may place the robot randomly, such that an initial position or heading of the robot forms an angle relative to surrounding walls. As a result, linear wall structures are displayed as oblique lines in a map constructed at a given resolution. Such oblique lines appear jagged to the naked eye, and the overall map may exhibit an apparent tilt, especially in home environments where walls are typically arranged in horizontal and vertical directions. Since the map often needs to be presented to the user through a graphical interface, the above issues significantly affect the visual quality and aesthetic appearance of the map.

Although rotating the map based on a principal direction can substantially reduce jagged artifacts and prevent map tilting, an existing approach generally performs principal direction detection only once at system startup. Due to complexity and unpredictability of real-world operating environments, such an approach often fails to achieve satisfactory results.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram of a robot according to one embodiment.

FIG. 2 is an exemplary flowchart of an indoor map construction method according to one embodiment.

FIG. 3 is an exemplary flowchart of a line detection process according to one embodiment.

FIG. 4 illustrates a schematic diagram of point cloud line detection results according to one embodiment.

FIG. 5 illustrates a schematic diagram of clustering multiple candidate lines according to one embodiment.

FIG. 6 illustrates a schematic diagram of an initial global map constructed when an angle exists between the robot's starting orientation and the overall indoor principal direction.

FIG. 7 illustrates a schematic diagram of a globally optimized map obtained after performing a third principal direction rotation on the initial global map shown in FIG. 6.

FIG. 8 illustrates a schematic diagram of an initial global map obtained when the robot's starting orientation is consistent with the orientation of a local indoor room,

FIG. 9 illustrates a schematic diagram of a globally optimized map obtained after principal direction adjustment using the method of the present disclosure.

FIG. 10 is a schematic block diagram illustrating an indoor map construction device according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

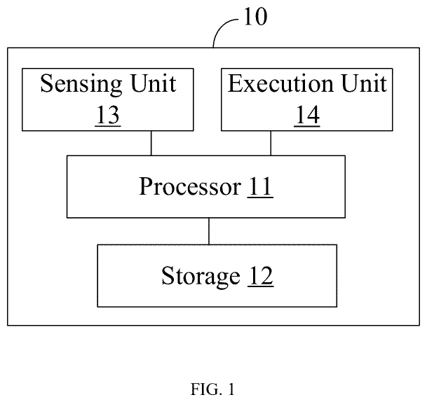

FIG. 1 illustrates a schematic block diagram of a robot 10 according to one embodiment. The robot 10 may be a cleaning robot, a cruising robot, or another type of robot having an indoor mapping capability. In one embodiment, the robot 10 includes a processor 11, a storage 12, and a sensing unit 13. The sensing unit 13 is disposed on a body of the robot 10 and is configured to sense external environmental information surrounding the robot 10. The storage 12 stores computer programs, and the processor 11 executes the computer programs to cause the robot 10 to perform the indoor map construction method according to the embodiments of the present disclosure, thereby ensuring accuracy of a principal direction of an entire map and preventing a global map displayed on a terminal from being tilted.

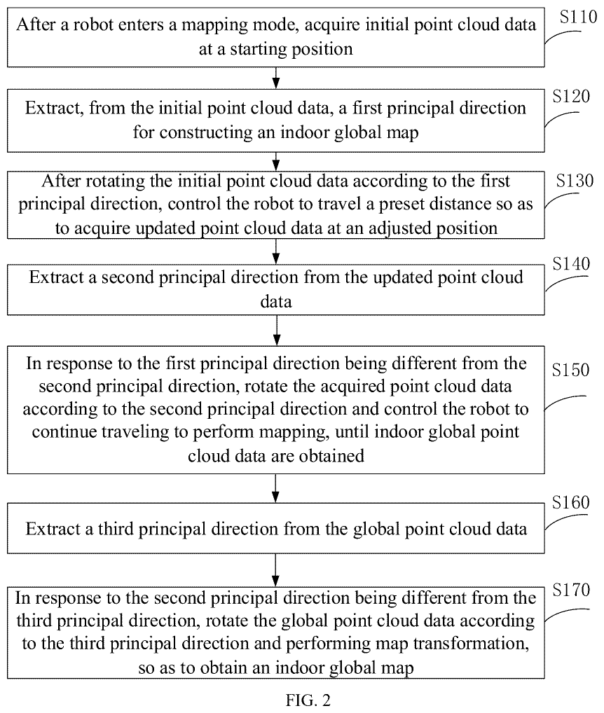

The storage 12, the processor 11, and the sensing unit 13 are directly or indirectly electrically connected to one another to enable data transmission or interaction. For example, these components can be electrically connected to one another through one or more communication buses or signal lines. The processor 11 performs corresponding operations by executing the executable computer programs stored in the storage 12. When the processor 11 executes the computer programs, the steps in the embodiments of an indoor map construction method, such as steps S110 to S170 in FIG. 2 are implemented.

The processor 11 may be an integrated circuit chip with signal processing capability. The processor 11 may be a central processing unit (CPU), a graphics processing unit (GPU), a general-purpose processor, a network processor (NP), a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 11 can implement or execute the methods, steps, and logical blocks disclosed in the embodiments of the present disclosure.

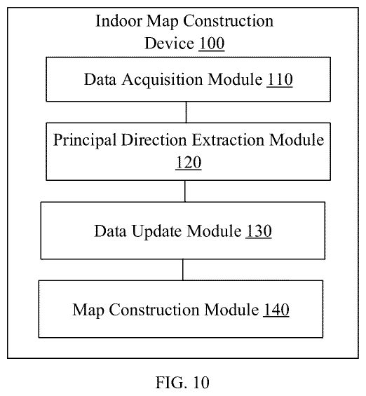

The storage 12 may be, but not limited to, a random-access memory (RAM), a read only memory (ROM), a programmable read only memory (PROM), an erasable programmable read-only memory (EPROM), and an electrical erasable programmable read-only memory (EEPROM). The storage 12 may be an internal storage unit of the robot, such as a hard disk or a memory. The storage 12 may be an external storage device of the robot, such as a plug-in hard disk, a smart memory card (SMC), and a secure digital (SD) card, or any suitable flash cards. Furthermore, the storage 12 may include both an internal storage unit and an external storage device. The storage 12 is to store computer programs, other programs, and data required by the robot. The storage 12 can be used to temporarily store data that has been output or is about to be output. Upon receiving an execution instruction, the processor 11 can correspondingly execute the computer program stored on the storage 12. The processor 11 executes various functional applications and data processing, thereby implementing the indoor map construction method described in the embodiments of the present disclosure, by running the software programs and modules stored in the storage 12, such as the at least one software functional module of the indoor map construction device 100 as shown in FIG. 10.

Exemplarily, the one or more computer programs may be divided into one or more modules/units, and the one or more modules/units are stored in the storage 12 and executable by the processor 11. The one or more modules/units may be a series of computer program instruction segments capable of performing specific functions, and the instruction segments are used to describe the execution process of the one or more computer programs in the electronic device.

The sensing unit 13 may include, but is not limited to, a LiDAR sensor. The LiDAR sensor can be used to obtain point cloud data of an external environment in which the robot 10 is currently located, and the obtained point cloud data can be utilized for functions such as two-dimensional mapping, three-dimensional mapping, distance measurement, autonomous navigation, and obstacle avoidance. Optionally, the sensing unit 13 may further include a camera, an infrared sensor, or other suitable sensing devices. For example, the infrared sensor can be used to obtain distance information relative to the external environment, and the camera can be used to acquire image information of the robot 10 during movement.

In one embodiment, the robot 10 may further include one or more execution units 14 disposed on the body of the robot 10. The execution units 14 may include, but are not limited to, a locomotion mechanism for enabling movement, such as rolling wheels or mechanical legs, and a cleaning mechanism for implementing cleaning functions, such as a spraying and washing component or a dirt removal component. It should be understood that specific structures of the execution units 14 may be determined according to actual requirements and are not described in detail herein.

It should be noted that the block diagram shown in FIG. 1 is only an example of the robot. The robot may include more or fewer components than what is shown in FIG. 1, or have a different configuration than what is shown in FIG. 1. Each component shown in FIG. 1 may be implemented in hardware, software, or a combination thereof.

It can be understood that the robot 10 described above is capable of performing indoor mapping. By implementing the indoor map construction method according to the embodiments of the present disclosure, that is, by performing three instances of principal direction extraction at different times to correct a principal direction, accuracy of the principal direction during map construction can be improved. As a result, an overall tilt of a global map during display can be avoided and jagged artifacts in the map can be reduced, thereby better conforming to user viewing habits. In addition, when performing principal direction rotation, the indoor map construction method according to the embodiments of the present disclosure converts rotation of the global map into rotation of point cloud data. In this way, time consumption associated with rotation of an entire global map can be significantly reduced, while environmental feature information is preserved.

The indoor map construction method is described below with reference to specific embodiments. FIG. 2 illustrates a flowchart of the indoor map construction method according to one embodiment. In one embodiment, the indoor map construction method may include steps S110 through S170.

Step S110: After a robot 10 enters a mapping mode, acquire initial point cloud data at a starting position.

Herein, a mapping mode refers to a working mode preconfigured in the robot 10. The mapping mode may be executed by the processor 11, or may be executed by a positioning and mapping module independently provided in the robot 10, which is not limited in the present disclosure. In the mapping mode, the robot 10 activates one or more LiDAR sensors to perform real-time point cloud data acquisition so as to obtain surrounding environmental information, thereby enabling tasks such as autonomous localization and map construction, obstacle avoidance, and the like.

It can be understood that each time the robot 10 acquires one frame of point cloud data (i.e., LiDAR data), the robot 10 stores the frame of point cloud data and records pose information of the robot 10 at a current time. Subsequently, based on detection point information contained in the frame of point cloud data and the pose information, coordinates of the detection points in a mapping coordinate system can be determined, thereby realizing localization and mapping. It can be understood that the point cloud data collected by robot 10 is based on the LiDAR coordinate system, while the mapping coordinate system refers to the coordinate system used by robot 10 during indoor mapping.

It should be noted that after the robot 10 starts mapping, a mapping coordinate system for indoor mapping is generally determined based on initial pose information of the robot 10. Specifically, an initial position of the robot 10 is set as an origin of the mapping coordinate system, an initial heading direction of the robot 10 is set as a positive X-axis direction, and a direction perpendicular to the initial heading direction is set as a positive Y-axis direction. Therefore, when the initial heading direction of the robot 10 at the starting position is inclined relative to, or perpendicular to, a length direction of indoor walls, a finally generated global map may be tilted, and wall lines in the map may appear jagged.

To address the above issues, the present disclosure proposes extracting a principal direction three times based on point cloud data acquired at different times, and converting rotation of a map into rotation of point cloud data, thereby performing detection and correction of the principal direction. In this way, rotation accuracy and accuracy of the principal direction are improved, and an overall tilt and jagged appearance of a constructed global map are avoided.

Exemplarily, after the robot 10 is placed at a certain indoor position (referred to as a starting position) and a mapping mode is enabled, the robot 10 rotates in place for one full rotation. During the rotation, the robot 10 controls the one or more LiDAR sensors to emit laser beams outward so as to acquire corresponding point cloud data. The point cloud data acquired at this stage are referred to as initial point cloud data.

Step S120: Extract, from the initial point cloud data, a first principal direction for constructing an indoor global map.

In one embodiment, the starting position is regarded as a first time point for principal direction extraction, and is mainly used to determine whether the starting position is suitable for determining a principal direction for indoor mapping. For example, when multiple elongated furnishings (such as sofas or long tables) are present around the starting position of the robot 10, or when an initial heading direction of the robot 10 forms an angle with surrounding walls, a principal direction extracted therefrom may be inclined or even invalid. In such cases, a principal direction determined based on the starting position is not suitable for use as a mapping principal direction.

In one embodiment, line detection is first performed on the initial point cloud data, and a reference line is then determined based on the detected lines, which is used as the principal direction for mapping. It should be noted that, in one embodiment, a same principal direction extraction method may be applied for each extraction, and a difference lies only in point cloud data used for each principal direction extraction. Specifically, the point cloud data used for principal direction extraction include initial point cloud data acquired at the starting position, updated point cloud data acquired at a position located a predetermined distance from the starting position, and global point cloud data acquired after traversing an entire indoor environment.

Before performing the first principal direction extraction, as an optional solution, the method may further include performing keyframe stitching on the initial point cloud data to obtain stitched point cloud data, such that the stitched point cloud data are used as base data for principal direction extraction.

For example, keyframes may be extracted from the initial point cloud data, and the extracted keyframes are then stitched to obtain the stitched point cloud data. During keyframe extraction, keyframes may be selected at predetermined frame intervals, after the robot travels a short distance, or after the robot rotates by a predetermined angle, which is not limited in the present disclosure. The number of keyframes used for stitching mainly depends on an occlusion angle caused by other structures (such as pillars) of the robot 10 blocking a LiDAR sensor mounted on the body of the robot 10. For example, when the occlusion angle is relatively small, two frames may be selected for stitching; when the occlusion angle is larger, a greater number of frames may be selected.

It can be understood that the purpose of stitching is twofold. On one hand, due to an installation position of the LiDAR sensor(s), field-of-view occlusion may occur, and thus point cloud data from different angles can be stitched to obtain 360-degree omnidirectional data. On the other hand, the stitched point cloud data are denser, which is more favorable for subsequent line detection processing.

The following description takes stitched point cloud data as an example to illustrate how principal direction extraction is performed. It can be understood that principal direction extraction may also be performed directly based on the initial point cloud data, and the stitched point cloud data are merely used herein as an example to illustrate the principal direction extraction process.

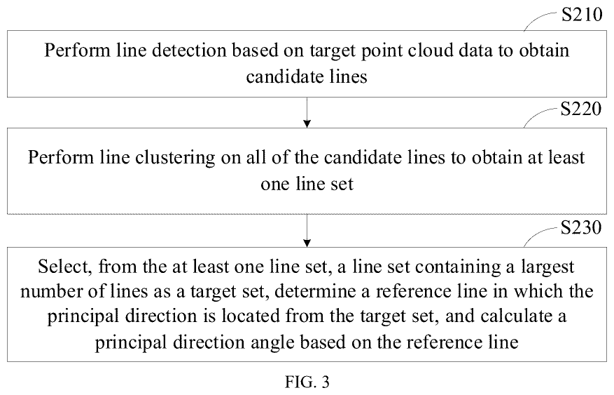

In one embodiment, as illustrated in FIG. 3, the principal direction extraction process includes the following steps.

Step S210: Perform line detection based on target point cloud data to obtain candidate lines.

The target point cloud data herein are initial point cloud data or stitched point cloud data obtained based on the initial point cloud data. For example, line detection may be performed using a linear regression algorithm. Specifically, a random sample consensus (RANSAC) algorithm and/or a least squares method may be employed. Considering that the point cloud data may include a large number of points and computation based solely on the least squares method may be time-consuming, in order to achieve lightweight computation, the present embodiment combines the RANSAC algorithm with the least squares method to perform rapid line detection. Under conditions where the model is predetermined and a maximum number of iterations is specified, the RANSAC algorithm is capable of finding an optimal solution.

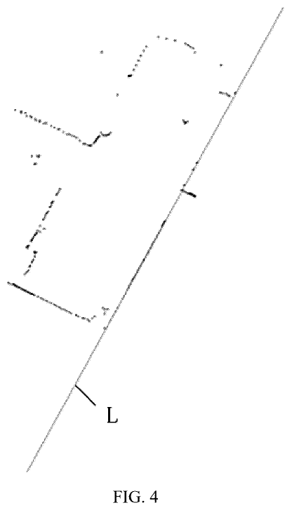

In one embodiment, a preset number of points are randomly sampled from the target point cloud data as target samples, and it is assumed that the target samples belong to a same plane model. Subsequently, line fitting is performed on the target samples using the least squares method to obtain parameters of the plane model. Further, when the parameters of the plane model are known, the RANSAC algorithm is used to iteratively update the model parameters so as to obtain a plane model having optimal parameters. The plane model having the optimal parameters includes fitted candidate lines. For example, FIG. 4 illustrates one of the candidate lines L detected from the target point cloud data.

Specifically, during iteration of the model parameters, a distance from each point in the point cloud data to a current plane model under the current parameters is calculated. Points whose distances are less than a predetermined threshold are considered inliers, thereby obtaining a number of inliers for the current sampling. Conversely, points whose distances are greater than or equal to the predetermined threshold are considered outliers. If the number of inliers in the current sampling exceeds that from the previous sampling, it indicates that the plane model under the current parameters encompasses more inliers, suggesting that the computed model parameters at this stage are superior. Therefore, it is necessary to iteratively update the parameters of the plane model based on the current results, and then repeat the aforementioned random sampling operation and inlier count evaluation. This process continues until the preset sampling count is reached, at which point the iteration stops and the optimal parameters of the plane model are output. It can be understood that by ensuring a sufficient number of sampling iterations, the probability of randomly selected points all being inliers increases, thereby correspondingly reducing the likelihood of outliers affecting the model.

Regarding the determination of the number of samplings, it can be obtained by calculating the probability that randomly selected n points are all inliers. Expressed mathematically, P_{f}=(1−Wⁿ)^{k}=1−p, where Wⁿ represents the probability that all n randomly selected points are inliers, P_{f} represents the probability of selecting at least one outlier, and k represents the number of samplings. By taking the logarithm of the above equation, the number of samplings k can be calculated as: k=log(1−p)/log(1−Wⁿ).

Step S220: Perform line clustering on all of the candidate lines to obtain at least one line set.

In one embodiment, a multi-line clustering method is employed to detect lines that serve as the principal direction. Exemplarily, lines that are approximately parallel and perpendicular are grouped into the same class, and the class containing the largest number of lines constitutes a line set.

In one embodiment, all candidate lines that are parallel or approximately parallel in a first direction, as well as lines that are perpendicular or approximately perpendicular to the first direction in a second direction, are grouped into the same class to form a line set. The approximately parallel or approximately perpendicular lines are required to have an included angle within a predetermined angular range, for example, not exceeding 5 to 10 degrees.

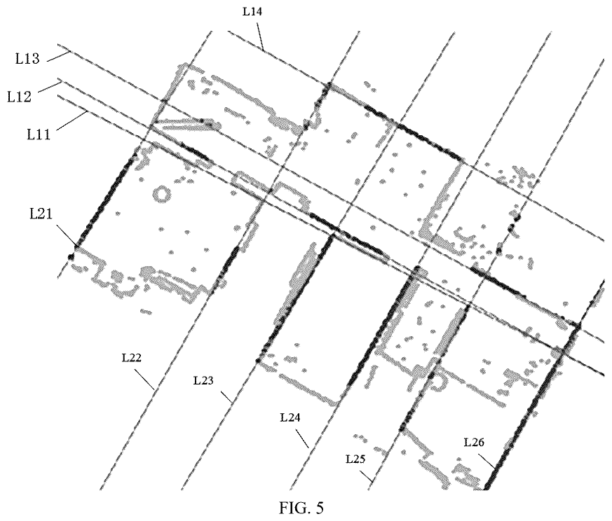

For example, with reference to several candidate lines illustrated in FIG. 5, approximately parallel candidate lines L11-L14, as well as lines L21-L26 that are perpendicular or approximately perpendicular to any of L11-L14, are grouped into the same class to form a line set. Subsequently, a principal direction is determined from the line set, and an angle between the principal direction and the horizontal or vertical direction is calculated.

Optionally, after obtaining the above-described line set, remaining candidate lines may be grouped into another class to form an additional line set. Whether to use this additional line set can be determined according to practical requirements.

It can be understood that, considering that walls in typical indoor environments are mostly vertical, in the present embodiment, lines that are approximately parallel and approximately perpendicular are grouped into the same class, and particularly, mutually perpendicular lines are included in the same class as the parallel lines. This approach effectively addresses special scenarios, such as right-angled triangular arrangements within indoor environments. In fact, in conventional solutions, the longest detected line is often selected as the principal direction, which may correspond to a hypotenuse. However, in practice, selecting the two perpendicular sides as principal directions is often more reasonable and yields a greater total line length. Therefore, the multi-line clustering method described herein can detect principal directions corresponding to the perpendicular sides.

Step S230: Select, from the at least one line set, a line set containing a largest number of lines as a target set, determine a reference line in which the principal direction is located from the target set, and calculate a principal direction angle based on the reference line.

The principal direction angle refers to an angle between the reference line serving as the principal direction and a horizontal line (X-axis) or a vertical line (Y-axis), which can serve as a basis for subsequent map rotation or point cloud rotation, such that the global map for display extends either along the horizontal direction or the vertical direction.

In one embodiment, the principal direction may be determined from the line set containing the largest number of lines. For instance, the longest line in the set may be selected as the reference line and used as the principal direction for mapping. Alternatively, the direction of the reference line may be determined based on a ratio between the number of parallel lines and perpendicular lines. For example, when the number of parallel or approximately parallel lines is greater, the longest line among these lines may be selected as the reference line, which then defines the principal direction. It can be understood that the above are merely illustrative examples and are not intended to be limiting.

In one embodiment, after the first principal direction is extracted, the method may further include: determining whether the first principal direction satisfies a predetermined condition. If the first principal direction does not satisfy the predetermined condition, it is deemed invalid. In this case, after the second principal direction is extracted, the point cloud data used for constructing the grid map are directly rotated to align with the second principal direction. It can be understood that by first determining whether the first principal direction has significant uncertainty, the second principal direction can be directly used as the latest principal direction for subsequent operations without needing to compare it with the first principal direction.

The predetermined condition includes at least one of the following situations: (1) A length of the longest line in the target line set exceeds a predetermined length. It can be understood that if the longest line in the line set containing the largest number of lines is relatively short, it indicates that no clear line or line feature can be found. In this case, the first extracted principal direction is deemed unsuitable. Conversely, if the longest line meets the predetermined length, the first principal direction can be retained for subsequent comparison with the second principal direction. (2) A difference in the number of lines between at least two line sets exceeds a predetermined threshold. It can be understood that if the number of lines in two line sets is approximately equal, the environment may not be suitable for detecting a global principal direction. For example, in indoor environments where sofas, long tables, or other elongated objects are arranged in directions inconsistent with the walls, such a phenomenon may occur. In this case, the first extracted principal direction is also deemed unsuitable. Conversely, if the difference is within the predetermined threshold, the first principal direction can be retained for subsequent comparison with the second principal direction.

Step S130: After rotating the initial point cloud data according to the first principal direction, control the robot to travel a preset distance so as to acquire updated point cloud data at an adjusted position.

The preset distance refers to a short distance from the starting position, for example, not exceeding 1 m, such as 20 cm, 50 cm, 70 cm, or the like, which is not limited in the present disclosure.

After the first principal direction is determined, if the first principal direction forms an angle with the X-axis or Y-axis of the mapping coordinate system, the initial point cloud data are rotated by the corresponding angle according to the first principal direction, such that the inclined reference line is rotated to a horizontal or vertical state. This helps to avoid the occurrence of jagged lines in the subsequently generated pixel-based global map.

Subsequently, the robot 10 is controlled to move a short distance and rotate in place, while using the LiDAR to acquire point cloud data of the current environment. Compared with the initial point cloud data, the acquired data at this stage are updated and referred to as the updated point cloud data. The reason for controlling the robot to move a short distance is to further determine the suitability of the starting position as a principal direction extraction moment, and, if unsuitable, to assess whether the adjusted current environment can be used as the basis for a new principal direction extraction.

Step S140: Extract a second principal direction from the updated point cloud data.

It can be understood that the process for extracting the second principal direction may follow the same method as described above for the first principal direction, with the only difference being that the target point cloud data in this case correspond to the updated point cloud data. For brevity, the description is not repeated here.

Optionally, before calculating the second principal direction, it is further possible to determine whether the updated point cloud data satisfy corresponding conditions to ensure their suitability for the second principal direction extraction. For example, the predetermined condition may include detecting whether the updated point cloud exhibits significant feature changes compared to the initial point cloud, such as the addition or alteration of new features exceeding a predetermined number. If so, the updated point cloud data may be used to extract the second principal direction. If not, the second principal direction extraction may be omitted. Optionally, the robot may move a short distance and perform the second principal direction extraction when a substantial increase in features is observed.

Further optionally, before extracting the second principal direction, the updated point cloud data may also be subjected to keyframe stitching, so that the stitched point cloud data can be used for principal direction extraction. The implementation of keyframe stitching may follow the same process as described above for the initial point cloud data, and is not repeated here for brevity.

Step S150: In response to the first principal direction being different from the second principal direction, rotate the acquired point cloud data according to the second principal direction and control the robot to continue traveling to perform mapping, until indoor global point cloud data are obtained.

In the embodiment, the first and second principal directions are compared. If they are the same, it indicates that no adjustment of the principal direction is required, and the robot may continue to move and construct the map along the current principal direction according to the planned path until the global indoor point cloud data are obtained. If the first and second principal directions differ, the acquired point cloud data needs to be rotated to align with the second principal direction.

It can be understood that the point cloud data to be rotated may be the acquired updated point cloud data, all point cloud data obtained from the previous two extractions, or the effective point cloud data processed from all point cloud data for mapping purposes to reduce data processing volume. This is not specifically limited.

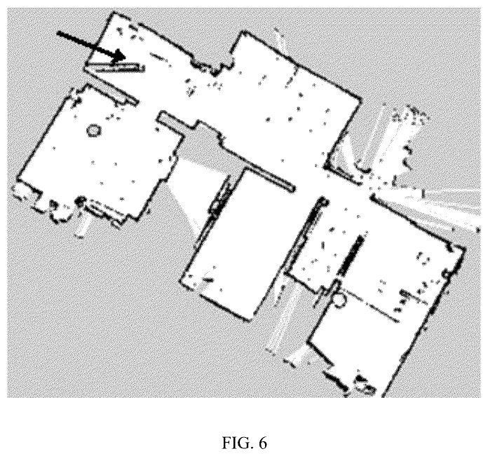

Generally, after the second principal direction is calculated, in most cases the first two principal direction detections and adjustments are sufficient to achieve an accurate principal direction. However, there are exceptional situations. For example, in an indoor environment, a particular room may be tilted relative to other rooms. If the robot 10 starts mapping in this room, the initial environment may cause the principal direction determined from the first two detections to be tilted along with the room. When the mapping of the entire house is completed, the overall actual principal direction may not be consistent with the principal direction extracted from the particular room or the initial environment. Similarly, when the robot 10 is placed at the starting position shown in FIG. 6 (indicated by the arrow), it can be seen that at this starting position there is an obstruction tilted relative to the vertical wall. Even after performing the second principal direction detection, the resulting global map is still tilted, and the wall lines appear jagged, as illustrated in FIG. 6.

Therefore, to avoid the aforementioned situations, in one embodiment, a third principal direction detection is performed after acquiring the global indoor point cloud data, so as to determine the final principal direction for constructing the map. In addition, in this embodiment, the principal direction rotation is implemented by rotating the point cloud data instead of repeatedly refreshing the keyframes of the pixel-based map. This approach can reduce the time required for rotating the principal direction of the global map while ensuring that the environmental feature information is not lost.

Step S160: Extract a third principal direction from the global point cloud data.

It can be understood that the process for extracting the third principal direction may follow the same method as described above for the first principal direction, with the only difference being that the target point cloud data in this case correspond to the global point cloud data. For brevity, the description is not repeated here.

Optionally, before extracting the third principal direction, the global point cloud data may be used to perform a map conversion to obtain an initial global map. For example, the global point cloud data may be projected onto a plane to generate a global planar map with a predetermined pixel resolution, and the planar map may then be rasterized to obtain a global grid map. If the second principal direction extracted subsequently is the same as the third principal direction, the initial global map may be used as the final global indoor map for display.

Step S170: In response to the second principal direction being different from the third principal direction, rotate the global point cloud data according to the third principal direction and performing map transformation, so as to obtain an indoor global map.

In one embodiment, if the principal direction extracted from the global point cloud data differs from the second principal direction, it indicates that the second principal direction is still inaccurate, and the third principal direction should be used for mapping. The principal direction extracted from the global point cloud data is considered the most accurate. It can be understood that when the first two principal directions are inconsistent, after initially rotating to align with the second principal direction and performing movement and LiDAR scanning to acquire point cloud data, if the third principal direction differs from the second principal direction, the acquired global point cloud data should be rotated to align with the third principal direction to obtain a compliant global indoor map.

It should be noted that, unlike the prior art, in the present embodiment, map rotation is achieved by rotating the point cloud data, such that most of the lines in the resulting global map are displayed in horizontal and vertical alignment rather than in a tilted orientation.

Optionally, in extracting the third principal direction, the process may further include: first performing sparsification on the global point cloud data to obtain sparse point cloud data; and then extracting the third principal direction from the sparse point cloud data and performing point cloud rotation and map conversion based on the third principal direction.

For example, during sparsification, the global point cloud data may first be projected onto a plane to obtain a global planar map with a first pixel resolution, and then the global planar map may be rasterized to obtain a grid map. Subsequently, a single point cloud may be retained for each pixel grid as a representative of the corresponding pixel. In one embodiment, the average position of the multiple point clouds within each pixel grid of the grid map may be calculated, and the obtained average may be used as the position information of the single point cloud retained for that pixel grid. Alternatively, in another embodiment, the multiple point clouds corresponding to each pixel grid may be clustered, and the resulting cluster center may be used as the position information of the single point cloud retained for that pixel grid.

It should be noted that the first pixel resolution may be higher than the pixel resolution typically used for displaying indoor maps. For example, the pixel resolution of an indoor map is usually set to 0.025 m/pix or 0.05 m/pix, whereas the first pixel resolution may be set to 0.01 m/pix or the like, but is not limited thereto, as long as it is higher than the pixel resolution of the global map used for final display. This is because, after sparsification of the point cloud within each pixel grid, using a higher pixel resolution can better preserve the integrity of the features after rotation while reducing the computational load of the global point cloud. Accordingly, this effectively addresses the problems in the prior art where rotating based on a grid map results in low accuracy and significant feature loss, as well as the long processing time caused by rotating historical point cloud data and then updating the map.

In one embodiment, the point cloud rotation and map conversion using the third principal direction include: rotating the sparse point cloud data in the LiDAR coordinate system to the third principal direction to obtain rotated point cloud data in the mapping coordinate system, and then projecting the rotated point cloud data onto a plane to obtain an indoor global map with a second pixel resolution.

Specifically, during the point cloud rotation, the coordinates of each point in the sparse point cloud data are multiplied by a rotation matrix generated based on the angle of the third principal direction, thereby obtaining the rotated point cloud data with updated positions. The rotated point cloud data is then projected onto a two-dimensional plane, resulting in a global map with the second pixel resolution suitable for display on a user terminal. The second pixel resolution may correspond to the commonly used pixel resolution for indoor map display.

It should be understood that both the second pixel resolution mentioned and the first pixel resolution described above are manually set, and they may be equal or different. Preferably, the first pixel resolution is generally higher than the second pixel resolution. For example, the first pixel resolution may be set to 0.01 m/pix while the second pixel resolution may be set to 0.05 m/pix, or the first pixel resolution may be set to 0.025 m/pix while the second pixel resolution may be set to 0.05 m/pix. These are merely exemplary options and are not limiting.

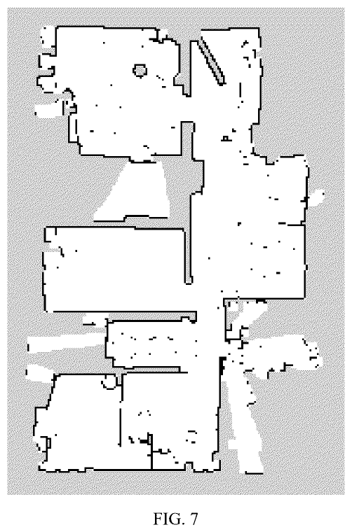

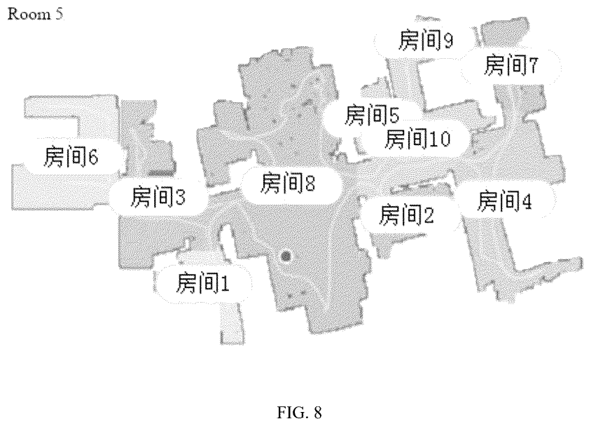

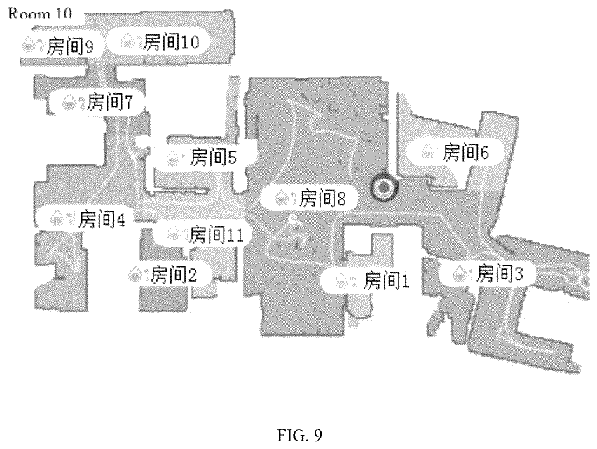

Taking the initial global map constructed as shown in FIG. 6 as an example, after rotating the map to align with the third principal direction, an adjusted global map as illustrated in FIG. 7 can be obtained. In addition, the indoor map construction method according to the embodiments of the present disclosure is also applicable to scenarios in which the starting position is aligned with the current room but tilted relative to other areas. For example, as shown in FIG. 8, if the robot 10 starts map construction in room 6, a global map aligned with this room may initially be obtained, but other rooms may appear tilted upon completion of the map construction. By employing the three-stage principal direction adjustment and map display adjustment according to the present embodiments, a global map as shown in FIG. 9 can be obtained, in which most of the lines are aligned horizontally and vertically. This is because the embodiments of the present disclosure adopt a method in which lines that are approximately parallel and perpendicular are clustered into multiple line sets, and the principal direction is extracted from the line set containing the most lines. Clearly, this method results in a more regular global map.

The indoor map construction method in the embodiments of the present disclosure ingeniously utilizes a mechanism for detecting the principal direction at different moments and employs precise point cloud data for principal direction determination. When rotating the global map, in order to generate accurate point cloud data, the point cloud is first sparsified and a higher pixel-resolution grid map is preserved. Then, by performing a coordinate rotation on the sparse point cloud, an accurate rotated point cloud is obtained, which is finally used to generate a global map for display on the terminal interface. This series of operations effectively avoids the time-consuming problem associated with performing global map conversion based on historical keyframe point cloud data. In addition, by adopting the above multi-line clustering method to determine the principal direction, the accuracy of the global map's principal direction is ensured, significantly reducing the occurrence of jagged lines in the constructed global map and preventing the map from appearing tilted, thereby achieving a better visual effect.

It should be understood that sequence numbers of the foregoing processes do not mean an execution sequence in the above-mentioned embodiments. The execution sequence of the processes should be determined according to functions and internal logic of the processes, and should not be construed as any limitation on the implementation processes of the above-mentioned embodiments.

FIG. 10 illustrates a schematic block diagram of an indoor map construction device 100 according to one embodiment. The indoor map construction device 100 may include a data acquisition module 110, a principal direction extraction module 120, a data update module 130, and a map construction module 140.

The data acquisition module 110 is to, after a robot 10 enters a mapping mode, acquire initial point cloud data at a starting position. The principal direction extraction module 120 is to extract, from the initial point cloud data, a first principal direction for constructing an indoor global map. The data update module 130 is to, after rotating the initial point cloud data according to the first principal direction, control the robot to travel a preset distance so as to acquire updated point cloud data at an adjusted position. The principal direction extraction module 120 is further to extract a second principal direction from the updated point cloud data. The data update module 130 is further to, in response to the first principal direction being different from the second principal direction, rotate the acquired point cloud data according to the second principal direction and control the robot to continue traveling to perform mapping, until indoor global point cloud data are obtained. The principal direction extraction module 120 is further to extract a third principal direction from the global point cloud data. The map construction module 140 is to, in response to the second principal direction being different from the third principal direction, rotate the global point cloud data according to the third principal direction and performing map transformation, so as to obtain an indoor global map.

In one embodiment, the data update module 130 is further to, in response to the first principal direction being the same as the second principal direction, controlling the robot to continue traveling to perform mapping until the indoor global point cloud data are obtained.

In one embodiment, the map construction module 140 is further to, perform map transformation based on the global point cloud data to obtain an initial global map and use the initial global map as the indoor global map for display in response to the second principal direction being the same as the third principal direction.

In one embodiment, the data update module 130 is further to, after extracting the first principal direction, determine whether the first principal direction satisfies a preset condition; in response to the preset condition being satisfied, detect whether the first principal direction is the same as the second principal direction; and in response to the preset condition being not satisfied, determine that the first principal direction is invalid, and rotate the acquired point cloud data to align with the second principal direction after the second principal direction is extracted;

In one embodiment, the principal direction extraction module 120 is further to perform sparsification processing on the global point cloud data to obtain sparse point cloud data. The sparse point cloud data is used for point cloud rotation and map transformation.

It should be noted that the device 100 in this embodiment corresponds to the indoor map construction method described in the foregoing embodiments, and the optional features described in those embodiments are equally applicable to this embodiment, and thus are not repeated herein.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In one embodiment, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented indoor map construction method, comprising:
after a robot enters a mapping mode, acquiring initial point cloud data at a starting position;
extracting, from the initial point cloud data, a first principal direction for constructing an indoor global map;
after rotating the initial point cloud data according to the first principal direction, controlling the robot to travel a preset distance so as to acquire updated point cloud data at an adjusted position;
extracting a second principal direction from the updated point cloud data;
in response to the first principal direction being different from the second principal direction, rotating the acquired point cloud data according to the second principal direction and controlling the robot to continue traveling to perform mapping, until indoor global point cloud data are obtained;
extracting a third principal direction from the global point cloud data; and
in response to the second principal direction being different from the third principal direction, rotating the global point cloud data according to the third principal direction and performing map transformation, so as to obtain an indoor global map.

2. The method of claim 1, further comprising:
in response to the first principal direction being the same as the second principal direction, controlling the robot to continue traveling to perform mapping until the indoor global point cloud data are obtained.

3. The method of claim 1, further comprising: performing map transformation based on the global point cloud data to obtain an initial global map after the indoor global point cloud data are obtained; and after extracting the third principal direction from the global point cloud data, in response to the second principal direction being the same as the third principal direction, using the initial global map as the indoor global map for display.

4. The method of claim 1, wherein extracting the first principal direction, the second principal direction, and the third principal direction comprises:
performing line detection based on target point cloud data to obtain candidate lines, wherein the target point cloud data are the initial point cloud data, the updated point cloud data, or the global point cloud data;
performing line clustering on all of the candidate lines to obtain at least one line set;
selecting, from the at least one line set, a line set containing a largest number of lines as a target set, determining a reference line in which the principal direction is located from the target set, and calculating a principal direction angle based on the reference line.

5. The method of claim 4, wherein performing line clustering on all of the candidate lines to obtain at least one line set comprises:
classifying, among all of the candidate lines, lines in a first direction that are parallel or approximately parallel to each other and lines in a second direction that are perpendicular or approximately perpendicular to the first direction into a same category, so as to obtain one line set, wherein the approximately parallel lines or the approximately perpendicular lines satisfy that an included angle between corresponding two lines falls within a preset angle range; and
after obtaining the one line set, classifying remaining lines among all of the candidate lines into another category, so as to obtain another line set.

6. The method of claim 4, further comprising, after extracting the first principal direction,
determining whether the first principal direction satisfies a preset condition;
in response to the preset condition being satisfied, detecting whether the first principal direction is the same as the second principal direction; and
in response to the preset condition being not satisfied, determining that the first principal direction is invalid, and rotating the acquired point cloud data to align with the second principal direction after the second principal direction is extracted;
wherein the preset condition comprises at least one of the following: a length of a longest line in the target set exceeds a preset length; and a difference in a number of lines between at least two of the line sets exceeds a preset threshold.

7. The method of claim 4, wherein performing line detection based on target point cloud data comprises:
performing line detection on the target point cloud data using a random sample consensus algorithm and a least squares method, comprising:
randomly sampling a preset number of points from the target point cloud data as target samples;
performing line fitting using the least squares method based on the target samples, so as to obtain parameters of a plane model;
calculating a distance between each point in the target point cloud data and a current plane model, and designating points having distances smaller than a preset threshold as inliers, so as to obtain a number of inliers for a current sampling; and
in response to the number of inliers for the current sampling being greater than a number of inliers for a previous sampling, updating parameters of the plane model, until a preset number of samplings is reached, and outputting latest parameters of the plane model; wherein the plane model corresponding to the latest parameters comprises a plurality of fitted candidate lines.

8. The method of claim 4, further comprising, before rotating the global point cloud data according to the third principal direction and performing map transformation,
performing sparsification processing on the global point cloud data to obtain sparse point cloud data, the sparse point cloud data being configured for point cloud rotation and map transformation; wherein the sparsification processing comprises:
projecting the global point cloud data onto a plane to obtain a planar map with a first pixel resolution, and performing gridding on the planar map to obtain a grid map;
for each pixel grid in the grid map, calculating an average value of a plurality of point clouds within the pixel grid, and using the calculated average value as position information of a single point cloud point retained in the corresponding pixel grid; or
for each pixel grid in the grid map, performing clustering on a plurality of point clouds corresponding to the pixel grid, and using an obtained cluster center value as position information of a single point cloud point retained in the corresponding pixel grid.

9. The method of claim 8, wherein rotating the global point cloud data according to the third principal direction and performing map transformation, comprises:
rotating sparse point cloud data in a LiDAR coordinate system to align with the third principal direction, so as to obtain rotated point cloud data in a mapping coordinate system, and performing planar projection on the rotated point cloud data to obtain an indoor global map with a second pixel resolution; wherein the first pixel resolution is higher than the second pixel resolution.

10. A robot comprising:
one or more processors; and
a memory coupled to the one or more processors, the memory storing programs that, when executed by the one or more processors, cause performance of operations comprising:
after a robot enters a mapping mode, acquiring initial point cloud data at a starting position;
extracting, from the initial point cloud data, a first principal direction for constructing an indoor global map;
after rotating the initial point cloud data according to the first principal direction, controlling the robot to travel a preset distance so as to acquire updated point cloud data at an adjusted position;
extracting a second principal direction from the updated point cloud data;
in response to the first principal direction being different from the second principal direction, rotating the acquired point cloud data according to the second principal direction and controlling the robot to continue traveling to perform mapping, until indoor global point cloud data are obtained;
extracting a third principal direction from the global point cloud data; and
in response to the second principal direction being different from the third principal direction, rotating the global point cloud data according to the third principal direction and performing map transformation, so as to obtain an indoor global map.

11. The robot of claim 10, wherein the operations further comprise:
in response to the first principal direction being the same as the second principal direction, controlling the robot to continue traveling to perform mapping until the indoor global point cloud data are obtained.

12. The robot of claim 10, wherein the operations further comprise: performing map transformation based on the global point cloud data to obtain an initial global map after the indoor global point cloud data are obtained; and after extracting the third principal direction from the global point cloud data, in response to the second principal direction being the same as the third principal direction, using the initial global map as the indoor global map for display.

13. The robot of claim 10, wherein extracting the first principal direction, the second principal direction, and the third principal direction comprises:
performing line detection based on target point cloud data to obtain candidate lines, wherein the target point cloud data are the initial point cloud data, the updated point cloud data, or the global point cloud data;
performing line clustering on all of the candidate lines to obtain at least one line set; and
selecting, from the at least one line set, a line set containing a largest number of lines as a target set, determining a reference line in which the principal direction is located from the target set, and calculating a principal direction angle based on the reference line.

14. The robot of claim 13, wherein performing line clustering on all of the candidate lines to obtain at least one line set comprises:
classifying, among all of the candidate lines, lines in a first direction that are parallel or approximately parallel to each other and lines in a second direction that are perpendicular or approximately perpendicular to the first direction into a same category, so as to obtain one line set, wherein the approximately parallel lines or the approximately perpendicular lines satisfy that an included angle between corresponding two lines falls within a preset angle range; and
after obtaining the one line set, classifying remaining lines among all of the candidate lines into another category, so as to obtain another line set.

15. The robot of claim 13, wherein the operations further comprise, after extracting the first principal direction,
determining whether the first principal direction satisfies a preset condition;
in response to the preset condition being satisfied, detecting whether the first principal direction is the same as the second principal direction; and
in response to the preset condition being not satisfied, determining that the first principal direction is invalid, and rotating the acquired point cloud data to align with the second principal direction after the second principal direction is extracted;
wherein the preset condition comprises at least one of the following: a length of a longest line in the target set exceeds a preset length; and a difference in a number of lines between at least two of the line sets exceeds a preset threshold.

16. The robot of claim 13, wherein performing line detection based on target point cloud data comprises:
performing line detection on the target point cloud data using a random sample consensus algorithm and a least squares method, comprising:
randomly sampling a preset number of points from the target point cloud data as target samples;
performing line fitting using the least squares method based on the target samples, so as to obtain parameters of a plane model;
calculating a distance between each point in the target point cloud data and a current plane model, and designating points having distances smaller than a preset threshold as inliers, so as to obtain a number of inliers for a current sampling; and
in response to the number of inliers for the current sampling being greater than a number of inliers for a previous sampling, updating parameters of the plane model, until a preset number of samplings is reached, and outputting latest parameters of the plane model; wherein the plane model corresponding to the latest parameters comprises a plurality of fitted candidate lines.

17. The robot of claim 13, wherein the operations further comprise, before rotating the global point cloud data according to the third principal direction and performing map transformation,
performing sparsification processing on the global point cloud data to obtain sparse point cloud data, the sparse point cloud data being configured for point cloud rotation and map transformation; wherein the sparsification processing comprises:
projecting the global point cloud data onto a plane to obtain a planar map with a first pixel resolution, and performing gridding on the planar map to obtain a grid map;
for each pixel grid in the grid map, calculating an average value of a plurality of point clouds within the pixel grid, and using the calculated average value as position information of a single point cloud point retained in the corresponding pixel grid; or
for each pixel grid in the grid map, performing clustering on a plurality of point clouds corresponding to the pixel grid, and using an obtained cluster center value as position information of a single point cloud point retained in the corresponding pixel grid.

18. The robot of claim 17, wherein rotating the global point cloud data according to the third principal direction and performing map transformation, comprises:
rotating sparse point cloud data in a LiDAR coordinate system to align with the third principal direction, so as to obtain rotated point cloud data in a mapping coordinate system, and performing planar projection on the rotated point cloud data to obtain an indoor global map with a second pixel resolution; wherein the first pixel resolution is higher than the second pixel resolution.

19. A non-transitory computer-readable storage medium storing instructions that, when executed by at least one processor of a robot, cause the at least one processor to perform an indoor map construction method, the method comprising:
after a robot enters a mapping mode, acquiring initial point cloud data at a starting position;
extracting, from the initial point cloud data, a first principal direction for constructing an indoor global map;
after rotating the initial point cloud data according to the first principal direction, controlling the robot to travel a preset distance so as to acquire updated point cloud data at an adjusted position;
extracting a second principal direction from the updated point cloud data;
in response to the first principal direction being different from the second principal direction, rotating the acquired point cloud data according to the second principal direction and controlling the robot to continue traveling to perform mapping, until indoor global point cloud data are obtained;
extracting a third principal direction from the global point cloud data; and
in response to the second principal direction being different from the third principal direction, rotating the global point cloud data according to the third principal direction and performing map transformation, so as to obtain an indoor global map.

20. The non-transitory computer-readable storage medium of claim 19, further comprising:
in response to the first principal direction being the same as the second principal direction, controlling the robot to continue traveling to perform mapping until the indoor global point cloud data are obtained.
